(19) United States
(12) Patent Application Publication
(10) Pub. No.: US 2006/0201248 A1
(43) Pub. Date: Sep. 14, 2006

(54) Vibrating gyro element

(76) Inventor: Yukihiro Unno, Okaya-shi (JP)

Correspondence Address: ANDERSON KILL & OLICK P.C., 1251 Avenue of the Americas, New York, NY, 10020, US

(21) Appl. No.: 11/371,999

(22) Filed: Mar. 8, 2006

(30) Foreign Application Priority Data
Mar. 11, 2005 (JP) 2005-068690

(51) Int. Cl. G01P 15/08

(52) U.S. Cl. 73/504.12

(57) ABSTRACT

A vibrating gyro element that is formed of a piezoelectric material having a trigonal crystal structure and having a trigonal axis with respect to the Y-axis, includes a base portion, a detection arm extending in the Y-axis direction from one side of the base portion, and a pair of drive arms extending from the detection arm. One of the pair of drive arms extends in a direction at an angle of substantially +120 degrees with respect to the Y-axis direction. The other of the pair of drive arms extends in a direction at an angle of substantially −120 degrees with respect to the Y-axis direction. The drive arms exist on substantially the same plane as the base portion and the detection arm.

### BACKGROUND

1. Technical Field

The present invention relates to a vibrating gyro element that employs a piezoelectric material having a trigonal crystal structure.

2. Related Art

In recent years, gyro sensors that detect angular velocity are frequently used for camera-shake correction in imaging apparatuses and position detection for automobiles and so forth by vehicle navigation systems employing GPS satellite signals.

As a vibrating gyro element included in a gyro sensor, e.g. a so-called double T-shape vibrating gyro element is known in which substantially T-shape drive vibration systems are disposed symmetrically with respect to the center detection vibration systems (refer to JP-A-2004-245605, FIG. 1). In the double T-shape vibrating gyro element, a base portion is provided with substantially T-shape drive vibration systems including drive arms and support arms, and detection vibration systems including detection arms. A Coriolis force arising in the drive arm is extracted via the support arm and the base portion from the detection arm.

However, in the vibrating gyro element with such a structure, since a Coriolis force is transmitted to the detection arm via the support arm and base portion, energy loss is large, which lowers the sensitivity of angular velocity detection. In addition, the base portion for supporting the vibrating gyro element is tightly fixed, which causes a problem that the sensitivity of angular velocity detection is significantly lowered, since the base portion is also involved in the balanced vibration of the vibrating gyro element.

### SUMMARY

An advantage of some aspects of the invention is to provide a vibrating gyro element that involves less energy loss in the transmission of Coriolis forces relating to angular velocity detection, and thus is superior in the sensitivity of angular velocity detection.

According to a first aspect of the invention, there is provided a vibrating gyro element that is formed of a piezoelectric material having a trigonal crystal structure and having a trigonal axis with respect to the Y-axis. The vibrating gyro element includes a base portion, a detection arm extending in the Y-axis direction from one side of the base portion, and a pair of drive arms extending from the detection arm. One of the pair of drive arms extends in a direction at an angle of substantially +120 degrees with respect to the Y-axis direction. The other of the pair of drive arms extends in a direction at an angle of substantially −120 degrees with respect to the Y-axis direction. The drive arms exist on substantially the same plane as the base portion and the detection arm.

According to the first aspect, the drive arms and the detection arm are formed along the Y-axis and the equivalent axes, from which charges are easily extracted. In addition, since the drive arms are directly coupled to the detection arm, Coriolis forces generated in the drive arms can be transmitted to the detection arm efficiently. Therefore, energy loss in the transmission of Coriolis forces is small, and thus a vibrating gyro element superior in the sensitivity of detecting the angular velocity can be provided.

Furthermore, the vibrating gyro element of the first aspect is formed only of the base portion, the drive arms and the detection arm, and thus has a simplified structure, which allows the miniaturization thereof.

Moreover, since the base portion has no relation to drive and detection vibrations, the base portion can be fixed tightly, which allows the achievement of a vibrating gyro element having superior shock resistance.

According to a second aspect of the invention, there is provided a vibrating gyro element that is formed of a piezoelectric material having a trigonal crystal structure and having a trigonal axis with respect to the Y-axis. The vibrating gyro element includes a base portion, a pair of detection arms extending in the Y-axis direction from both sides of the base portion, and a pair of drive arms extending from the detection arm. One of the pair of drive arms extends in a direction at an angle of substantially +120 degrees with respect to the Y-axis direction. The other of the pair of drive arms extends in a direction at an angle of substantially −120 degrees with respect to the Y-axis direction. The drive arms exist on substantially the same plane as the base portion and the detection arms.

According to the second aspect, the drive arms and the detection arms are formed along the Y-axis and the equivalent axes, from which charges are easily extracted. In addition, since the drive arms are directly coupled to the detection arm, Coriolis forces generated in the drive arms can be transmitted to the detection arm efficiently. Therefore, energy loss in the transmission of Coriolis forces is small, and thus a vibrating gyro element superior in the sensitivity of detecting the angular velocity can be provided.

In addition, since the vibrating gyro element of the second aspect includes a pair of detection arms, acceleration and so on acting as a disturbance in angular velocity detection can be cancelled, which allows the highly reliable detection of angular velocity.

Moreover, since the base portion has no relation to drive and detection vibrations, the base portion can be fixed tightly, which allows the achievement of a vibrating gyro element having superior shock resistance.

In the vibrating gyro element according to the second aspect, it is preferable that a groove is provide in a plane of each of the drive arms and the detection arms, the plane intersecting the thickness direction of the drive arms and the detection arms.

Such a structure enhances the electric field efficiency and thus yields large strains in drive and detection vibrations, which allows the miniaturization of a vibrating gyro element.

In the vibrating gyro element according to the second aspect, it is preferable that a weight is provided at a tip of each of the drive arms.

Such a structure increases the mass of the drive arms and thus allows the generation of large Coriolis forces, which enables the miniaturization of a vibrating gyro element.

In the vibrating gyro element having a weight at a tip of each of the drive arms, it is preferable that a groove is provide in a plane of each of the drive arms and the detection arms, the plane intersecting the thickness direction of the drive arms and the detection arms.

The provision of a weight at the tip of each of the drive arms increases the mass of the drive arms and thus provides large Coriolis forces. In addition, the provision of grooves in the drive arms and the detection arms enhances the electric field efficiency and thus yields large strains, in drive and detection vibrations. Accordingly the sensitivity of angular velocity detection of the vibrating gyro element is enhanced, which allows the miniaturization thereof.

In the vibrating gyro element according to the second aspect, it is preferable that a weight is provided at a tip of each of the drive arms and the detection arms.

Such a structure increases the mass of the drive arms, which allows the generation of large Coriolis forces. In addition, strains arising in the detection arms can also be increased. Thus, the sensitivity of angular velocity detection of the vibrating gyro element is enhanced, which allows the miniaturization thereof.

In the vibrating gyro element having a weight at a tip of each of the drive arms and the detection arms, it is preferable that a groove is provide in a plane of each of the drive arms and the detection arms, the plane intersecting the thickness direction of the drive arms and the detection arms.

The provision of a weight at the tip of each of the drive arms and the detection arms increases the mass of the drive arms so as to provide large Coriolis forces, and also increases strains arising in the detection arms. Furthermore, the provision of grooves in the drive arms and the detection arms enhances the electric field efficiency and thus yields large strains, in drive and detection vibrations. Accordingly the sensitivity of angular velocity detection of the vibrating gyro element is enhanced, which allows the miniaturization thereof.

### BRIEF DESCRIPTION OF THE DRAWINGS

The invention will be described with reference to the accompanying drawings, wherein like numbers reference like elements.

FIG. 1 is a plan view illustrating the structure of a vibrating gyro element according to a first embodiment of the invention.

FIG. 2 is a schematic diagram illustrating the form of a drive vibration.

FIGS. 3A and 3B are schematic diagrams illustrating the form of a detection vibration.

FIG. 4 is a plan view illustrating the structure of a vibrating gyro element according to a second embodiment of the invention.

FIG. 5 is a schematic diagram illustrating the form of a drive vibration.

FIGS. 6A and 6B are schematic diagrams illustrating the form of a detection vibration.

FIG. 7 is a schematic diagram illustrating a state in which acceleration is applied to a vibrating gyro element.

FIG. 8 is a plan view illustrating a modification of the second embodiment.

FIGS. 9A and 9B are sectional views of a drive arm and a detection arm, respectively

FIG. 10 is a plan view illustrating another modification of the second embodiment.

FIG. 11 is a plan view illustrating still another modification of the second embodiment.

FIG. 12 is a plan view illustrating a further modification of the second embodiment.

FIG. 13 is a plan view illustrating a yet further modification of the second embodiment.

FIG. 14 is an explanatory diagram illustrating each of crystallographic axes in quartz as seen from the Z-axis direction thereof.

### DESCRIPTION OF EXEMPLARY EMBODIMENTS

Prior to description of embodiments of the invention, the configuration of crystallographic axes in a trigonal crystal structure will be described below.

FIG. 14 is an explanatory diagram illustrating each of crystallographic axes in quartz as seen from the Z-axis direction thereof.

Quartz 100 has the X-axis called an electric axis, the Y-axis called a mechanical axis, and the Z-axis called an optical axis. The quartz 100 has a trigonal crystal structure. Therefore, in 360-degree rotation about the Z-axis, the same crystallographic figure is obtained three times. In the plane perpendicular to the Z-axis, the axis perpendicular to the X-axis is the Y-axis. Both the X- and Y-axes have the crystallographically equivalent axes (X₁, X₂, X₃ and Y₁, Y₂, Y₃) that make an angle of 120 degrees with one another. The axis perpendicular to the plane including the equivalent axes offset by 120 degrees from one another, i.e., the Z-axis is referred to as a trigonal axis (three-fold symmetry axis).

In the following description of embodiments, the crystallographic axes of the X₁-axis and the Y₁-axis are expressed as the X-axis and the Y-axis, respectively, for convenience, and the indication of the X₂-, X₃-, Y₂-, and Y₃ axes is omitted.

Embodiments of the invention will be described below with reference to the drawings.

### First Embodiment

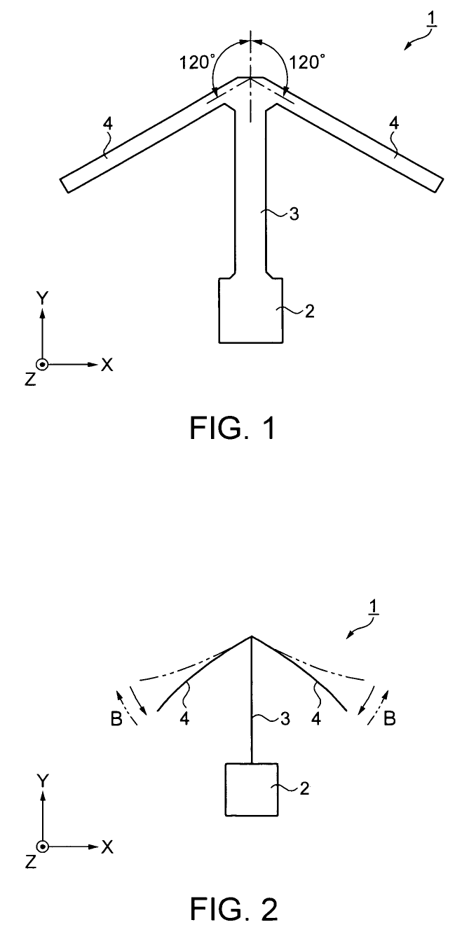

FIG. 1 is a plan view illustrating a vibrating gyro element according to a first embodiment of the invention.

A vibrating gyro element 1 is formed from a Z-cut plate of quartz by etching processing employing photolithography. The Z-cut plate is a quartz substrate of which thickness direction is the Z-axis direction and of which plane is parallel to the XY-plane.

The vibrating gyro element 1 includes a base portion 2, a detection arm 3 extending in the Y-axis direction from one side of the base portion 2, and a pair of drive arms 4 extending from the detection arm 3. One drive arm 4 extends in the direction at an angle of substantially +120 degrees with respect to the Y-axis direction. The other drive arm 4 extends in the direction at an angle of substantially −120 degrees with respect to the Y-axis direction. The extension directions of the drive arms 4 are designed to make an angle in the region of 120°±3° with the Y-axis in consideration of manufacturing variation.

In this manner, the detection arm 3 and the drive arms 4 are formed along the Y-axis and two equivalent axes (Y₁, Y₂, Y₃), which are the above-described crystallographic axes.

The base portion 2 supports the detection arm 3, and has a certain area so that it can be bonded to a substrate or the like.

Each of the drive arms 4 is provided with a drive electrode for driving the drive arm 4, and the detection arm 3 is provided with a detection electrode for detecting a strain of the detection arm 3 in a detection vibration thereof, although these electrodes are not illustrated in FIG. 1.

The operation of the vibrating gyro element 1 will be described below.

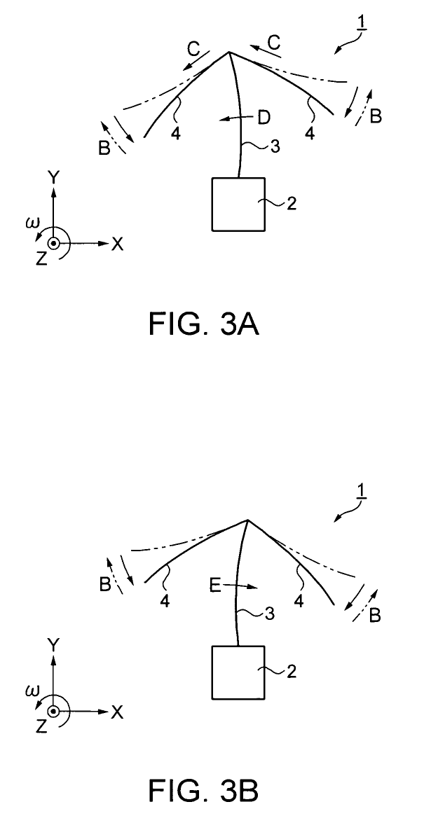

FIG. 2 is a schematic diagram for explaining the form of a drive vibration. FIGS. 3A and 3B are schematic diagrams for explaining the form of a detection vibration. In FIGS. 2, 3A and 3B, each arm is expressed by a line for simplified explanation of vibration forms.

In the drive vibration of FIG. 2, the pair of drive arms 4 of the vibrating gyro element 1 flexurally vibrate in the directions indicated by arrowheads B. This flexural vibration has a vibration behavior indicated by the full lines and chain double-dashed lines. Specifically the drive arms 4 oscillate with a certain frequency in the XY-plane so that the tips thereof repeatedly come close to and move away from the detection arm 3. At this time, the detection arm 3 does not vibrate.

When an angular velocity ω about the Z-axis is applied to the vibrating gyro element 1 in the state where a drive vibration arises, the vibration shown in FIG. 3A is caused. Specifically upon the application of the angular velocity ω, Coriolis forces arise in the drive arms 4 in the directions (indicated by arrowheads C) perpendicular to the drive vibration directions of the drive arms 4. In response to the generation of these Coriolis forces, the detection arm 3 is displaced in the direction indicated by arrowhead D. Subsequently as shown in FIG. 3B, the detection arm 3 is back displaced in the direction indicated by arrowhead E. Thus, excited in the detection arm 3 is a detection vibration in which the displacements in the directions of arrowheads D and E are repeated in the XY-plane. The strain of the piezoelectric material (quartz) arising due to this detection vibration is detected by the detection electrode formed on the detection arm 3, which allows the determination of the angular velocity ω.

When the angular velocity ω in the reverse direction is applied, Coriolis forces arising in the drive arms 4 act in the reverse directions, and therefore the initial displacement direction of the detection arm 3 is also the reverse direction. Accordingly, the polarity of the signal detected based on the strain of the detection arm 3 is opposite, which allows the recognition of the direction of the angular velocity ω.

As described above, in the vibrating gyro element 1 of the present embodiment, the drive arms 4 and the detection arm 3 extend in the Y-axis and the equivalent axes, from which charges are easily extracted. In addition, the drive arms 4 are directly coupled to the detection arm 3, which allows the efficient transmission of Coriolis forces generated in the drive arms 4 to the detection arm 3. Therefore, energy loss in the transmission of Coriolis forces is small, and thus the vibrating gyro element 1 superior in the sensitivity of detecting the angular velocity ω can be provided.

Furthermore, the vibrating gyro element 1 is formed only of the base portion 2, the detection arm 3 and the drive arms 4, and therefore has a simplified structure, which allows the size reduction thereof.

Moreover, since the base portion 2 has no relation to the drive and detection vibrations, the base portion 2 can be fixed tightly. Bonding the base portion 2 having a certain area to a substrate or the like allows the achievement of the vibrating gyro element 1 having superior shock resistance.

### Second Embodiment

A vibrating gyro element according to a second embodiment of the invention will be described.

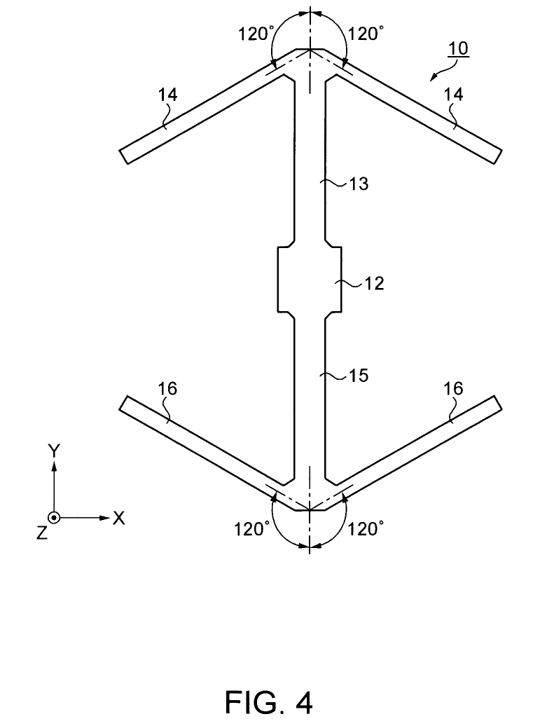

FIG. 4 is a plan view illustrating the structure of the vibrating gyro element.

A vibrating gyro element 10 is formed from quartz by etching processing employing photolithography

The vibrating gyro element 10 includes a base portion 12, detection arms 13 and 15 extending in the Y-axis direction from the both sides of the base portion 12, and pairs of drive arms 14 and 16 extending from the detection arms 13 and 15, respectively. The drive arms 14 extend in the directions at angles of substantially +120 and −120 degrees, respectively with respect to the Y-axis direction. The drive arms 16 also extend in the directions at angles of substantially +120 and −120 degrees, respectively, with respect to the Y-axis direction. The extension directions of the drive arms 14 and 16 are designed to make an angle in the region of 120°±3° with the Y-axis in consideration of manufacturing variation.

In this manner, the detection arms 13 and 15 and the drive arms 14 and 16 are formed along the Y-axis and two equivalent axes (Y₁, Y₂, Y₃), which are the above-described crystallographic axes.

The base portion 12 supports the detection arms 13 and 15, and has a certain area so that it can be bonded to a substrate or the like.

Each of the drive arms 14 and 16 is provided with a drive electrode for driving the drive arm, and the detection arms 13 and 15 are provided with a detection electrode for detecting a strain of the detection arm in a detection vibration thereof, although these electrodes are not illustrated in FIG. 4.

The operation of the vibrating gyro element 10 will be described below.

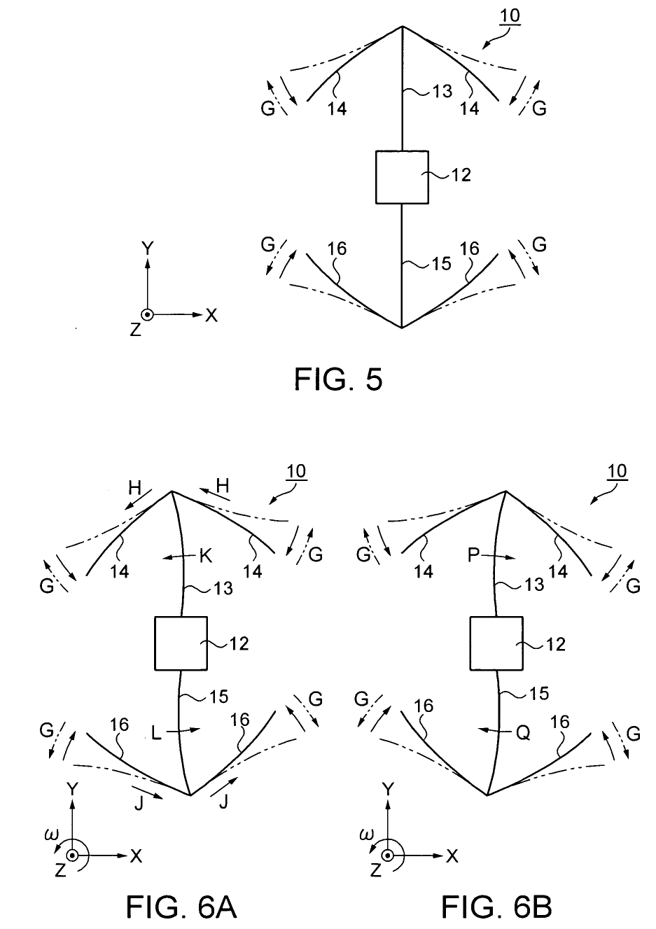

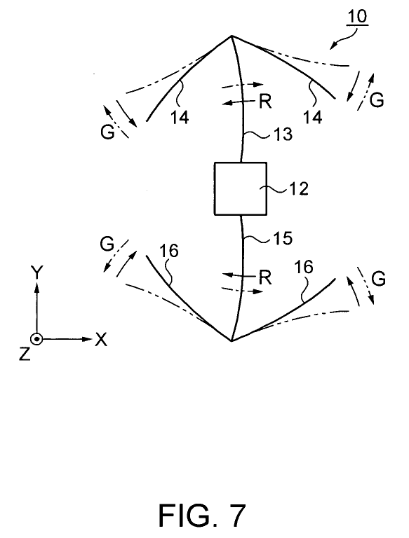

FIG. 5 is a schematic diagram for explaining the form of a drive vibration. FIGS. 6A and 6B are schematic diagrams for explaining the form of a detection vibration. FIG. 7 is a schematic diagram for explaining a vibration form when acceleration is applied to the vibrating gyro element. In FIGS. 5, 6A, 6B and 7, each arm is expressed by a line for simplified explanation of vibration forms.

In the drive vibration of FIG. 5, each of the pairs of drive arms 14 and 16 of the vibrating gyro element 10 flexurally vibrate in the directions indicated by arrowheads G. This flexural vibration has a vibration behavior indicated by the full lines and chain double-dashed lines. Specifically the drive arms 14 and 16 oscillate with a certain frequency in the XY-plane so that the tips thereof repeatedly come close to and move away from the detection arms 13 and 15, respectively. At this time, the detection arms 13 and 15 do not vibrate.

When an angular velocity ω about the Z-axis is applied to the vibrating gyro element 10 in the state where a drive vibration arises, the vibration shown in FIG. 6A is caused. Specifically upon the application of the angular velocity ω, Coriolis forces arise in the drive arms 14 in the directions (indicated by arrowheads H) perpendicular to the drive vibration directions of the drive arms 14. In response to the generation of these Coriolis forces, the detection arm 13 is displaced in the direction indicated by arrowhead K.

In addition, Coriolis forces also arise in the drive arms 16 in the directions (indicated by arrowheads J) perpendicular to the drive vibration directions of the drive arms 16. In response to the generation of these Coriolis forces, the detection arm 15 is displaced in the direction indicated by arrowhead L.

Subsequently, as shown in FIG. 6B, the detection arms 13 and 15 are back displaced in the directions indicated by arrowheads P and Q, respectively. Thus, excited in the detection arm 13 is a detection vibration in which the displacements in the directions of arrowheads K and P are repeated, while excited in the detection arm 15 is a detection vibration in which the displacements in the directions of arrowheads L and Q are repeated.

In this manner, when the angular velocity ω is applied to the vibrating gyro element 10, the detection arms 13 and 15 are displaced in the directions opposite to each other.

The strain of the piezoelectric material (quartz) arising due to this detection vibration is detected by the detection electrode formed on the detection arms 13 and 15, which allows the determination of the angular velocity ω.

When the angular velocity ω in the reverse direction is applied, Coriolis forces arising in the drive arms 14 and 16 act in the reverse directions, and therefore the initial displacement directions of the detection arms 13 and 15 are also the reverse directions. Accordingly each of the polarities of the signals detected based on the strains of the detection arms 13 and 15 is opposite, which allows the recognition of the direction of the angular velocity ω.

As described above, the drive arms 14 and 16 and the detection arms 13 and 15 extend in the Y-axis and the equivalent axes, from which charges are easily extracted. In addition, the drive arms 14 and 16 are directly coupled to the detection arms 13 and 15, which allows the efficient transmission of Coriolis forces generated in the drive arms 14 and 16 to the detection arms 13 and 15. Therefore, energy loss in the transmission of Coriolis forces is small, and thus the vibrating gyro element 10 superior in the sensitivity of detecting the angular velocity ω can be provided.

When acceleration in the X-axis direction is applied to the vibrating gyro element 10, as shown in FIG. 7, the detection arms 13 and 15 are displaced in the directions indicated full line arrowheads R, and then are back displaced in the directions indicated by the chain double-dashed arrowheads, and thus a vibration is excited. In this manner, when acceleration is applied to the vibrating gyro element 10, the detection arms 13 and 15 are displaced in the same direction.

That is, the combination of polarities of signals detected by the detection arms 13 and 15 when the angular velocity ω is applied is different from that when acceleration in the X-axis direction is applied. Therefore, the acceleration in the X-axis direction, which acts as a disturbance in the detection of the angular velocity ω, can be cancelled, which allows the highly reliable detection of the angular velocity ω.

Moreover, since the base portion 12 has no relation to the drive and detection vibrations, the base portion 12 can be fixed tightly. Bonding the base portion 2 having a certain area to a substrate or the like allows the achievement of the vibrating gyro element 10 having superior shock resistance.

Vibrating gyro elements as modifications of the above-described embodiments will be described below.

In the following description of the vibrating gyro elements, the same parts as those in the above description are given the same numerals, and description thereof will be omitted. In addition, the operation of the following vibrating gyro elements is the same as the above-described operation, and therefore is not described below.

First Modification

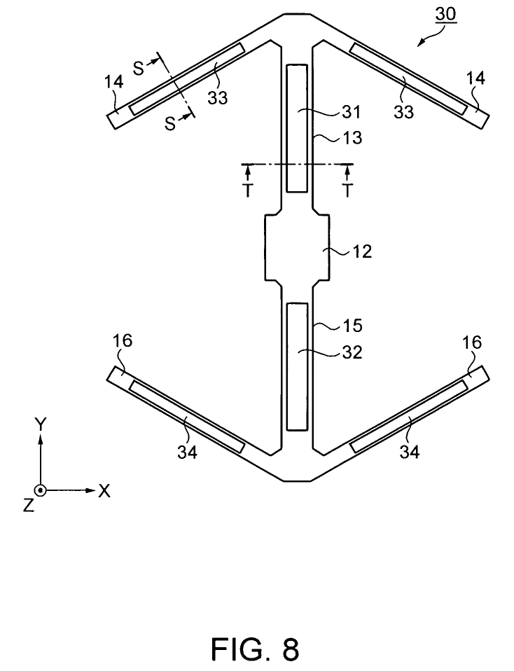

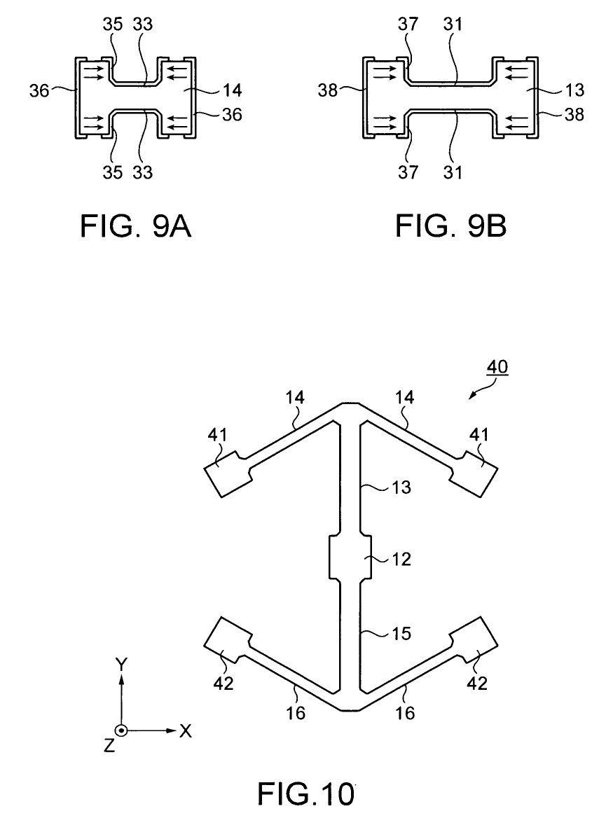

FIG. 8 is a plan view illustrating a vibrating gyro element as a first modification. FIGS. 9A and 9B are sectional views of a drive arm and a detection arm, respectively FIG. 9A is a schematic sectional view along line S-S in FIG. 8. FIG. 9B is a schematic sectional view along line T-T in FIG. 8.

Referring to FIG. 8, in a vibrating gyro element 30, grooves 33 and 34 are formed in drive arms 14 and 16, respectively and grooves 31 and 32 are formed in detection arms 13 and 15, respectively

In the drive arm 14 for example, as shown in FIG. 9A, the grooves 33 are formed in the planes intersecting the thickness direction thereof.

In addition, drive electrodes 35 and 36 are formed on the side faces of the drive arm 14 and in the grooves 33. The drive electrodes 35 and 36 are designed to have potentials of opposite polarities.

Similarly in the detection arm 13, as shown in FIG. 9B, the grooves 31 are formed in the planes intersecting the thickness direction thereof.

In addition, detection electrodes 37 and 38 are formed on the side faces of the detection arm 13 and in the grooves 31. The detection electrodes 37 and 38 are designed to have potentials of opposite polarities.

By thus providing the grooves in the drive arms 14 and 16 and the detection arms 13 and 15 of the vibrating gyro element 30, the drive electrodes 35 and 36 and the detection electrodes 37 and 38 can be placed in a manner of facing each other. In this case, as shown in FIGS. 9A and 9B, straight electric fields are generated across the electrodes, which allows the achievement of large electric fields. Thus, large strains can be produced. That is, drive vibrations of the drive arms 14 and 16 can be generated efficiently. In addition, large detection signals can be obtained from the detection arms 13 and 15 even when detection vibrations thereof are small.

As described above, the provision of the grooves 31, 32, 33 and 34 allows the enhancement of the electric field efficiency in drive and detection vibrations. Therefore, sufficiently large drive vibrations and sufficiently high detection sensitivity can be achieved even when the vibrating gyro element 30 is miniaturized.

Second Modification

FIG. 10 is a plan view illustrating a vibrating gyro element as a second modification.

In a vibrating gyro element 40, weights 41 and 42 are formed at the tips of drive arms 14 and 16, respectively

By thus forming the weights 41 and 42 at the tips of the drive arms 14 and 16, the mass of the drive arms 14 and 16 can be increased, which allows a lower eigenfrequency and a larger amplitude.

Thus, Coriolis forces arising in the drive arms 14 and 16 can be increased, which allows the miniaturization of the vibrating gyro element 40.

Third Modification

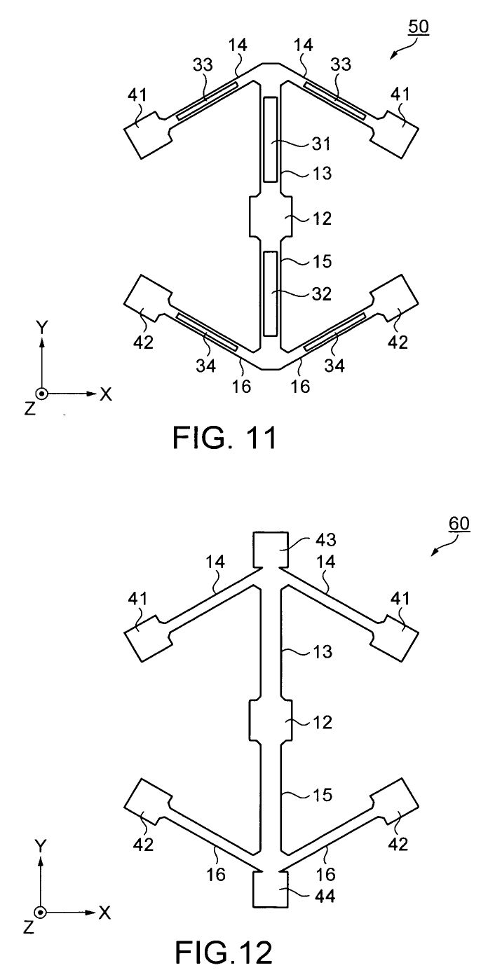

FIG. 11 is a plan view illustrating a vibrating gyro element as a third modification.

A vibrating gyro element 50 as the third modification has a structure obtained by providing grooves in the drive arms 14 and 16 and the detection arms 13 and 15 of the vibrating gyro element 40 described as the second modification (see FIG. 10).

In the vibrating gyro element 50, grooves 33 and 34 are formed in drive arms 14 and 16, respectively and grooves 31 and 32 are formed in detection arms 13 and 15, respectively. These grooves are formed in the planes (both planes) of the arms intersecting the thickness direction thereof.

The provision of weights 41 and 42 at the tips of the drive arms 14 and 16 can increase Coriolis forces arising in the drive arms 14 and 16. In addition, the provision of the grooves 33, 34, 31 and 32 in the drive arms 14 and 16 and the detection arms 13 and 15 can enhance the electric field efficiency in drive and detection vibrations. Thus, the sensitivity of angular velocity detection of the vibrating gyro element 50 is enhanced, which allows the miniaturization thereof.

Fourth Modification

FIG. 12 is a plan view illustrating a vibrating gyro element as a fourth modification.

A vibrating gyro element 60 as the fourth modification has a structure obtained by providing weights 43 and 44 at the tips of the detection arms 13 and 15 of the vibrating gyro element 40 described as the second modification (see FIG. 10).

By thus forming the weights 43 and 44 at the tips of the detection arms 13 and 15, the mass of the detection arms 13 and 15 can be increased, which allows a lower eigenfrequency and a larger amplitude. Thus, Coriolis forces arising in the drive arms 14 and 16 can be increased. In addition, strains arising in the detection arms 13 and 15 can also be increased. Accordingly the sensitivity of angular velocity detection of the vibrating gyro element 60 is enhanced, which allows the miniaturization thereof.

Fifth Modification

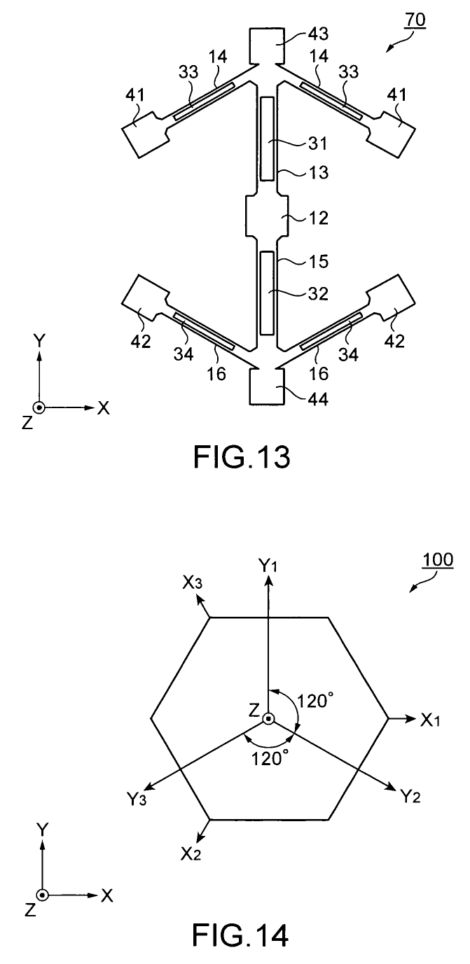

FIG. 13 is a plan view illustrating a vibrating gyro element as a fifth modification.

A vibrating gyro element 70 as the fifth modification has a structure obtained by providing grooves in the drive arms 14 and 16 and the detection arms 13 and 15 of the vibrating gyro element 60 described as the fourth modification (see FIG. 12).

In the vibrating gyro element 70, grooves 33 and 34 are formed in drive arms 14 and 16, respectively and grooves 31 and 32 are formed in detection arms 13 and 15, respectively. These grooves are formed in the planes (both planes) of the arms intersecting the thickness direction thereof.

By thus providing the weights 41, 42, 43 and 44 at the tips of the drive arms 14 and 16, and at the tips of the detection arms 13 and 15, Coriolis forces arising in the drive arms 14 and 16 can be increased, and strains arising in the detection arms 13 and 15 can be increased. Furthermore, the provision of the grooves 33, 34, 31 and 32 in the drive arms 14 and 16 and the detection arms 13 and 15 can enhance the electric field efficiency in drive and detection vibrations. Thus, the sensitivity of angular velocity detection of the vibrating gyro element 70 is enhanced, which allows the miniaturization thereof.

The examples in which the X₁-axis and the Y₁-axis are defined as the X-axis and the Y-axis, respectively have been described above. Alternatively the X₂-axis and the Y₂-axis may be defined as the X-axis and the Y-axis, respectively. Further alternatively, the X₃-axis and the Y₃-axis may be defined as the X-axis and the Y-axis, respectively

The vibrating gyro elements of the above-described embodiments and modifications can be achieved by using, instead of quartz, a piezoelectric material having a trigonal crystal structure, such as gallium phosphate (GaPO₄), lithium tantalate (LiTaO₃), lithium niobate (LiNbO₃), or langasite (La₃Ga₅SiO₁₄).

The entire disclosure of Japanese Patent Application No. 2005-068690, filed Mar. 11, 2005 is expressly incorporated by reference by reference herein.

What is claimed is:

1. A vibrating gyro element that is formed of a piezoelectric material having a trigonal crystal structure and having a trigonal axis with respect to the Y-axis, comprising:
a base portion;
a detection arm extending in the Y-axis direction from one side of the base portion; and
a pair of drive arms extending from the detection arm, one of the pair of drive arms extending in a direction at an angle of substantially +120 degrees with respect to the Y-axis direction, the other of the pair of drive arms extending in a direction at an angle of substantially −120 degrees with respect to the Y-axis direction, the drive arms existing on substantially the same plane as the base portion and the detection arm.

2. A vibrating gyro element that is formed of a piezoelectric material having a trigonal crystal structure and having a trigonal axis with respect to the Y-axis, comprising:
a base portion;
a pair of detection arms extending in the Y-axis direction from both sides of the base portion; and
a pair of drive arms extending from the detection arm, one of the pair of drive arms extending in a direction at an angle of substantially +120 degrees with respect to the Y-axis direction, the other of the pair of drive arms extending in a direction at an angle of substantially −120 degrees with respect to the Y-axis direction, the drive arms existing on substantially the same plane as the base portion and the detection arms.

3. The vibrating gyro element according to claim 2, wherein a groove is provide in a plane of each of the drive arms and the detection arms, the plane intersecting the thickness direction of the drive arms and the detection arms.

4. The vibrating gyro element according to claim 2, wherein a weight is provided at a tip of each of the drive arms.

5. The vibrating gyro element according to claim 4, wherein a groove is provide in a plane of each of the drive arms and the detection arms, the plane intersecting the thickness direction of the drive arms and the detection arms.

6. The vibrating gyro element according to claim 2, wherein a weight is provided at a tip of each of the drive arms and the detection arms.

7. The vibrating gyro element according to claim 6, wherein a groove is provide in a plane of each of the drive arms and the detection arms, the plane intersecting the thickness direction of the drive arms and the detection arms.
